(19) United States
(12) Patent Application Publication
(10) Pub. No.: US 2005/0133959 A1
(43) Pub. Date: Jun. 23, 2005

(54) System and method for producing multi-color polymeric components

(75) Inventor: Jerome J. Sroka, St. Clair Shores, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 10/745,090

(22) Filed: Dec. 22, 2003

(51) Int. Cl. B29C 41/08; B29C 41/22

(52) U.S. Cl. 264/245; 264/255; 425/96; 425/130

(57) ABSTRACT

A method for producing a polymeric component having two different colors is provided. A split mold design is used such that a coating having a first color is applied to a first piece of the mold while it is separated from a second piece of the mold. The two mold pieces are then brought together, and a coating having a second color is applied to the second mold piece. A bonding material is then sprayed on the two coatings, thereby forming a skin, which is an integrated, unitary structure. The skin may be further processed by applying a structural foam to create an automotive interior component having two different colors.

### BACKGROUND OF THE INVENTION

1. Field of the Invention

The present invention relates to a system and method for producing multi-color polymeric components.

2. Background Art

Aromatic spray polyurethane in-mold coating (IMC) has recently emerged as a cost effective method of producing a variety of different polymeric components. In some cases, spray polyurethane IMC has been able to replace reaction injection molding (RIM) in the production of rugged structural components. The spray polyurethane IMC process takes advantage of cross-link bonding between a coating, usually of a color desired for the finished component, and a polyurethane substrate. The part produced by the spray polyurethane IMC process can then be used in the manufacture of a component, such as an instrument panel for a vehicle, that does not need to be post painted. Indeed, the coating used in the spray polyurethane IMC process can be specifically chosen to match the vehicle interior.

In addition to facilitating production of monochrome parts, the spray polyurethane IMC process can also be used to produce parts having two or more colors. Of course, this adds complexity to the process. One method of producing a multi-color component using the spray polyurethane IMC process, involves masking a portion of a mold as the mold is sprayed with a coating having one color. The mask is then removed and a second color is sprayed on the mold. In this type of process, the masking material must be constantly cleaned or discarded, and must be applied and removed for each component produced. This adds time and cost to the operation, and requires messy cleanup even when the masking material is discarded.

Therefore a need exists for a method of producing a multi-color component using a process that eliminates the need to mask portions of the mold to produce a component having more than one color.

### SUMMARY OF THE INVENTION

Accordingly, the invention provides a method for producing a multi-color polymeric component using a mold having at least two pieces. The method includes applying a polymeric coating having a first color to a first piece of the mold. A polymeric coating having a second color is applied to a second piece of the mold. At least one of the coatings is applied when the first and second mold pieces are separated from each other. The two mold pieces are disposed in close proximity to each other, and a polymeric bonding material is applied to at least a portion of each coating, thereby integrating the coatings and the bonding material.

The invention also provides a method for producing a multi-color polymeric component using a mold having at least two pieces. The method includes spraying a first piece of the mold with a polymeric coating having a first color. A second piece of the mold is sprayed with a polymeric coating having a second color. At least one of the coatings is sprayed when the first and second mold pieces are separated from each other. The two mold pieces are disposed in close proximity to each other, and a polymeric bonding material is sprayed on at least a portion of each coating, thereby forming a unitary structure.

The invention further provides a system for producing a multi-color polymeric component. The system includes a mold having at least two pieces separable from each other and configured to cooperate with each other to facilitate production of an integrated component. At least one robotic spray arm is configured to spray polymeric coatings on the at least two mold pieces, and further configured to spray a polymeric bonding material on at least a portion of each coating, thereby forming an integrated component. A controller is provided for controlling operation of the at least one robotic spray arm such that a first piece of the mold is sprayed with a coating having a first color, and a second piece of the mold is sprayed with a coating having a second color. At least one of the coatings are sprayed when the first and second mold pieces are separated from each other.

### BRIEF DESCRIPTION OF THE DRAWINGS

FIG. 1 is a perspective view of a split mold for use in accordance with the present invention;

FIG. 2 is a flowchart illustrating a method of the present invention;

FIGS. 3A and 3B show a cross-sectional view of a two-piece mold used in accordance with the present invention;

FIG. 4 shows a two-color polymeric skin produced using the present invention;

FIG. 5 shows a cross-sectional view of a three-piece mold for use in accordance with the present invention;

FIG. 6 shows a three-color polymeric skin produced in accordance with the present invention; and

FIG. 7 shows a simplified schematic of a system used in accordance with the present invention.

### DETAILED DESCRIPTION OF THE PREFERRED EMBODIMENT(S)

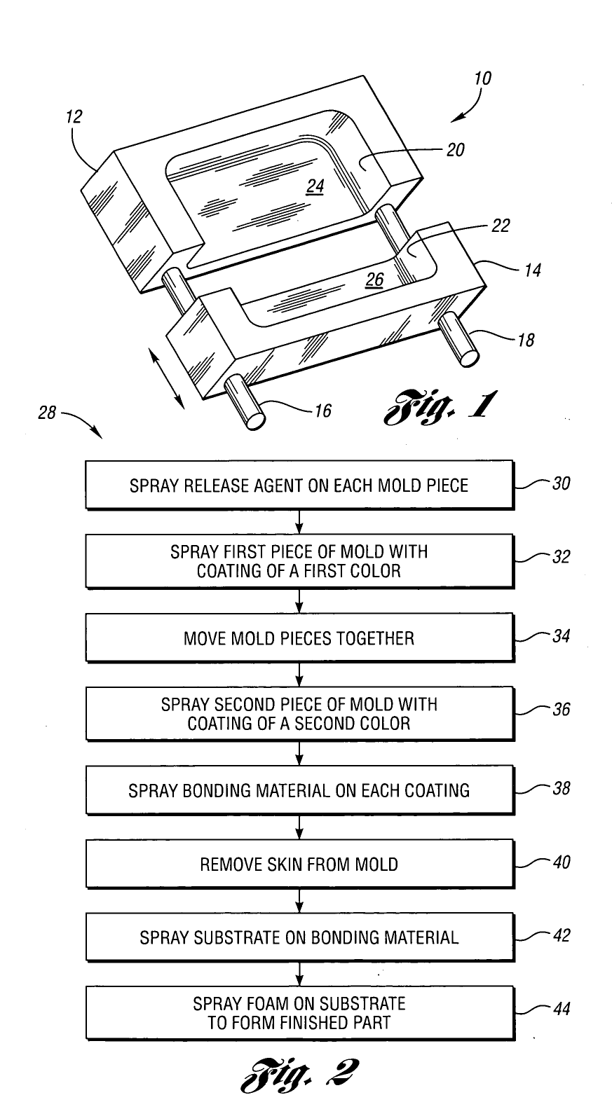

FIG. 1 shows a mold 10 that can be used in accordance with a system and method of the present invention. The mold 10 includes a first piece 12 and a second piece 14. As indicated by the directional arrow, the second mold piece 14 is movable along slides 16, 18. In this way, the two mold pieces 12, 14 can be separated or abutted against one another. As described below, the use of a split mold, such as the mold 10, facilitates the production of a two-color component.

The first mold piece 12 includes a first cavity 20, and the second mold piece 14 includes a second cavity 22. As shown in FIG. 1, the mold cavities 20, 22 do not include component details; however, a mold cavity can be produced with many details, having a net shape, or near net shape, of a finished component. The mold 10 can be manufactured from any material, or materials, which facilitate the molding of a finished component. Because of their durability, nickel alloys have been found to be particularly well suited for use in molds, such as the mold 10. In addition, a nickel alloy mold can be produced with a surface texture that provides a finished appearance for the molded component. For example, surfaces 24, 26 of mold cavities 20, 22 can be produced with a textured finish that will be molded into the finished component. Thus, if a particular texture is desired on the finished component, surfaces 24, 26 can be produced with a negative of that surface, so that the molded component has the desired texture without additional processing.

FIG. 2 shows a flowchart 28 illustrating a method in accordance with the present invention. With reference to the mold shown in FIG. 1, the first step 30 of the method includes spraying a release agent in each of the cavities 20, 22 of the mold pieces 12, 14. The release agent may be any material, including those currently used in the art, which facilitates easy removal of the molded component after the molding process is complete. For example, a silicone based material can be used to facilitate removal of the molded component, while not interfering with a chemical bonding of the polymeric components used in the molding process. At step 32, the first mold piece 12 has applied to it a coating having a first color. Various different types of coatings may be used in an IMC process, for example, a polymeric material having aliphate triiscocynate and polyols has been found to be effective.

When the coating is sprayed onto the first mold piece 12, the two mold pieces 12, 14 are separated from each other, as shown in FIG. 1. The illustration in FIG. 1 is greatly exaggerated, however, in that the two mold pieces 12, 14 can be separated by as little as one inch or smaller when the coating is applied to the first mold piece 12. Some care must be taken to avoid overspray, so that the coating is not inadvertently applied to the second mold piece 14. Controlling the application of the coating to the first mold piece 12, thereby allowing the mold pieces 12, 14 to be separated by a very small gap, facilitates rapid closing of the mold pieces 12, 14 in the next step.

At step 34, the mold pieces 12, 14 are brought in close proximity to each other, in fact, abutting one another. Movement of the second mold piece 14 along the slides 16, 18 can be effected with an actuator, which is particularly beneficial for large molds. As shown in FIG. 1, the smaller of the two mold pieces—i.e., the second mold piece 14—is moved toward the large mold piece 12. Of course, a mold, such as the mold 10, can be configured such that both mold pieces move toward each other simultaneously. After the two mold pieces 12, 14 are brought together, the second mold piece 14 has a coating applied to it that has a second color—i.e., a color different from the color of the coating applied to the first mold piece 12.

When the coating is applied to the first mold piece 12, care is taken to ensure that overspray does not contact the second mold piece 14. When the coating having the second color is applied to the second mold piece 14, no such precautionary measures are required. This is because the appearance surface of the finished component is at the interface of the mold 12 and the coating. Thus, if a second coating is sprayed into the cavity 24 of the first mold piece 12, it will merely coat the back side of the first coating, and will not be visible when the finished component is used in its final application. Of course, a coating may be applied to the second mold piece 14 prior to the two mold pieces 12, 14 being brought together, if desired. After the second mold piece 14 is coated, a bonding material, or substrate, is sprayed into the mold 10 to cover both of the coatings. As with the coatings, different materials may be used for the substrate; however, polymeric materials including polyurethanes have been found to be effective. Such a material can cross-link with the coatings, thereby integrating the coatings and the substrate into a unitary structure.

When the coatings and the substrate have cured, a skin is formed which can be removed from the mold 10—see step 40. At this point, the desired two-color component is complete; however, for many uses, it will be desirable to further process the skin. For example, at step 42, a substrate may be sprayed on the bonding material to facilitate application of a structural foam at step 44. This additional processing provides a relatively stiff component having desired structural characteristics, with a two-color surface finish having the texture of the mold cavity surfaces, such as the surfaces 24, 26.

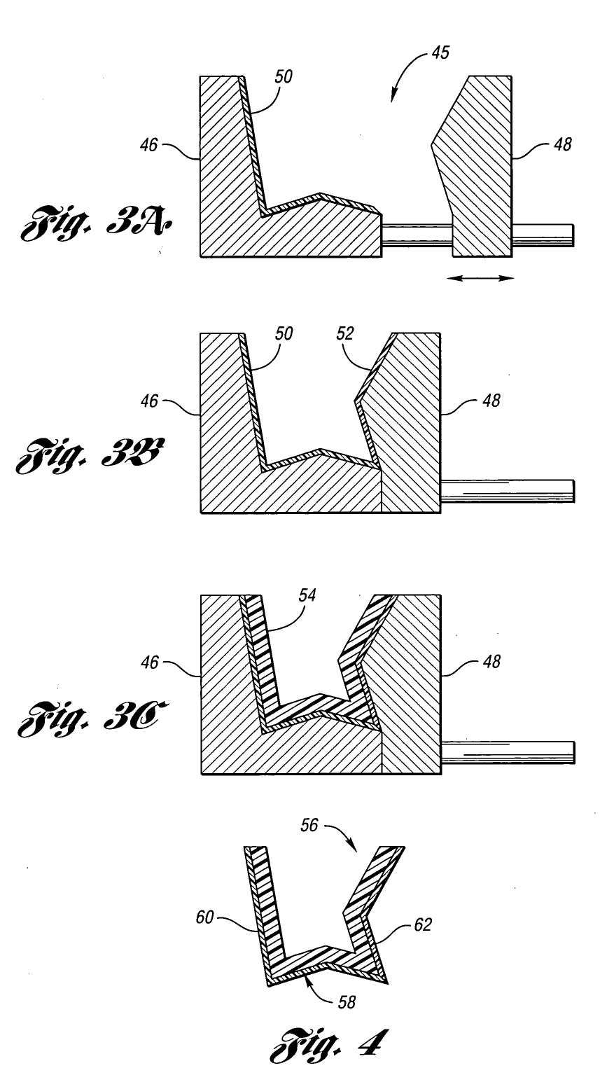

FIGS. 3A-3C schematically illustrate some of the method described in the flow chart 28 in FIG. 2. Shown in cross section is a mold 45, having first and second mold pieces 46, 48, which are initially separated from each other. The two mold pieces 46, 48 are then brought together as shown in FIG. 3B. A second coating 52 is applied to the second mold piece 48. Although the second coating 52 is applied after the mold pieces 46, 48 are brought together, it may, alternatively, be applied while the mold pieces 46, 48 are still separated. Moreover, although the coating of the two mold pieces 46, 48 is described sequentially, the process may be configured such that both coatings are simultaneously applied. After the coatings are applied, a bonding material, or substrate, 54 is applied to both coatings 50, 52—see FIG. 3C. Once the substrate 54 and the coatings 50, 52 are cured, an integrated, unitary structure, or skin 56, is the result—see FIG. 4.

As shown in FIG. 4, the skin 56 has a finished appearance surface 58 which comprises two differently colored surfaces 60, 62. Because the skin 56 is made from polyurethane materials, it will have a certain amount of flexibility and/or elasticity. Thus, the skin 56 may be deformed somewhat prior to the application of an additional substrate and foam structural material for the forming of a component, such as a vehicle instrument panel. In such an application, the surfaces 60, 62 would be outwardly facing the interior of the vehicle, thereby providing an aesthetically pleasing, multi-color interior component.

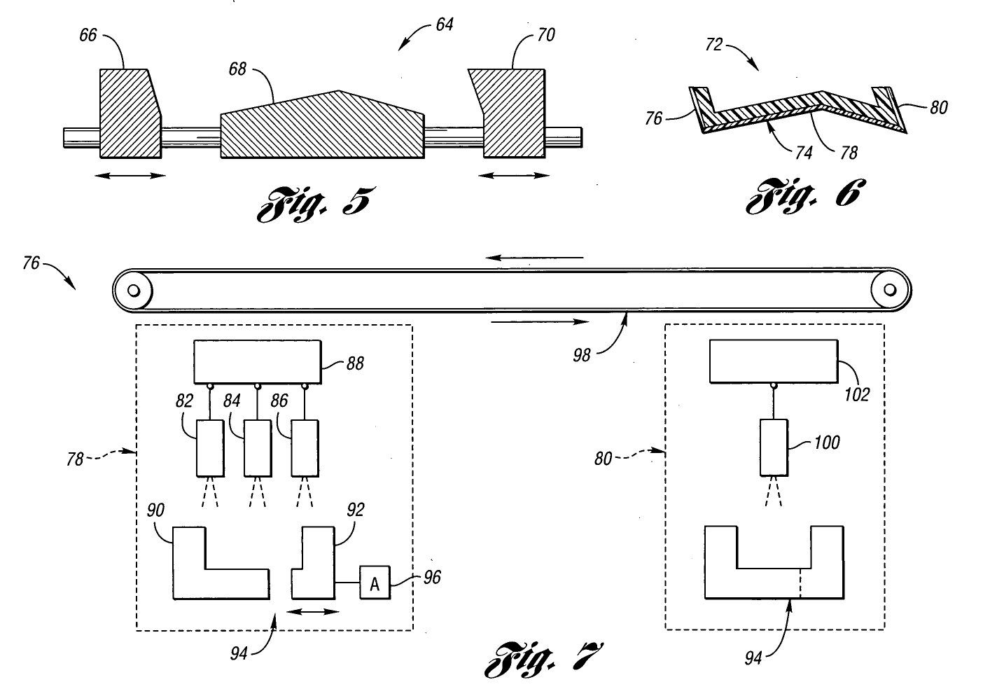

It is worth noting that the method described above it not limited to components having two colors; rather, components having any number of different colors can be produced with the present invention. For example, FIG. 5 shows a mold 64 having three mold pieces 66, 68, 70. With this configuration, a three-color component can be produced using steps similar to those described above. In such a method, coatings having three different colors would be applied to the respective mold pieces. At least two of the coatings would be applied when at least some of the mold pieces are separated from each other, for example, as shown in FIG. 5. The mold pieces 66, 68, 70 could then be brought together, and the third coating and/or a bonding material would be applied to each of the coatings to form a unitary structure.

As shown in FIG. 6, the skin 72 created using the mold 64, shown in FIG. 5, includes an appearance surface 74 comprising surfaces 76, 78, 80, each of which has a different color. As shown in FIG. 6, the skin 72 has a shallower profile than the skin 56 shown in FIG. 4, and therefore may be suitable for the production of an automotive door panel. In such an application, the surfaces 76, 78, 80 would each face the interior of the vehicle, thereby presenting an integrated multi-color door panel to the vehicle occupants.

FIG. 7 shows a system 76 for utilizing the methods described above. The system 76 includes first and second work stations 78, 80. Although the methods described above are conveniently performed with a system having two workstations, all of the processes can be integrated into a single workstation, or more than two workstations, as desired. The first workstation 78 includes three robotic spray arms 82, 84, 86, all of which are controlled by a single controller, or control unit 88. Alternatively, each robotic spray arm 82, 84, 86 may have a separate control unit. Because each of the spray arms 82, 84, 86 apply a different material, it is convenient to use three separate spray arms; however, a single robotic spray arm may be configured to perform all three functions.

The first spray arm 82 is configured to spray first and second pieces 90, 92 of a mold 94 with a release agent, as described above. The second spray arm 84 is configured to spray the first mold piece 90 with a coating having a first color. The first and second mold pieces 90, 92 are then brought together by a an actuator, such as the pneumatic cylinder 96. Of course, other types of actuators can be used, such as hydraulic cylinders or electric motors. A coating having a second color is then sprayed by the third spray arm 86 on the second mold piece 92. After the coatings are applied to the first and second mold pieces 90, 92, they are moved to the second workstation 80 via an overhead conveyor 98.

Once the mold 94 is at the second workstation 80, a fourth robotic spray arm 100 is used to apply a bonding material to the coatings, thereby forming an integrated component, or skin. As shown in FIG. 7, the fourth robotic spray arm has its own control unit 102, for controlling application of the bonding material. The foregoing method may also be carried out by a system that includes a single control unit configured to control a single robotic arm that is used to apply each of the various materials to a mold, such as the mold 94. Moreover, such a robotic spray arm may be configured to apply more than two different colored coatings to a multi-piece mold, such as the three-piece mold 64, shown in FIG. 5. As described above, a skin produced by a system, such as the system 76 shown in FIG. 7, can then be further processed by applying additional materials, such as a structural foam, to create an automotive component.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method for producing a multi-color polymeric component using a mold having at least two pieces, the method comprising:
applying a polymeric coating having a first color to a first piece of the mold;
applying a polymeric coating having a second color to a second piece of the mold, at least one of the coatings being applied when the first and second mold pieces are separated from each other;
disposing the mold pieces in close proximity to each other; and
applying a polymeric bonding material to at least a portion of each coating, thereby integrating the coatings and the bonding material.

2. The method of claim 1, further comprising:
applying a polymeric substrate to at least a portion of the bonding material; and
applying a polymeric foam to at least a portion of the substrate, thereby forming an automotive component.

3. The method of claim 2, wherein the automotive component is an instrument panel.

4. The method of claim 2, wherein the automotive component is a door panel.

5. The method of claim 1, wherein the bonding material includes a polyurethane material.

6. The method of claim 1, further comprising:
applying at least one additional polymeric coating having at least one color different from the first and second colors to a corresponding additional mold piece prior to application of the bonding material, thereby facilitating production of a component having at least three different colors.

7. The method of claim 1, further comprising applying a release agent to each of the mold pieces prior to applying a corresponding coating.

8. A method for producing a multi-color polymeric component using a mold having at least two pieces, the method comprising:
spraying a first piece of the mold with a polymeric coating having a first color;
spraying a second piece of the mold with a polymeric coating having a second color, at least one of the coatings being sprayed when the first and second mold pieces are separated from each other;
disposing the mold pieces in close proximity to each other; and
spraying a polymeric bonding material on at least a portion of each coating, thereby forming a unitary structure.

9. The method of claim 8, further comprising:
spraying a polymeric substrate on at least a portion of the bonding material; and
spraying a polymeric foam on at least a portion of the substrate, thereby forming an automotive component.

10. The method of claim 9, wherein the automotive component is an instrument panel.

11. The method of claim 9, wherein the automotive component is a door panel.

12. The method of claim 8, wherein the bonding material includes a polyurethane material.

13. The method of claim 8, further comprising:
spraying at least one additional polymeric coating having at least one color different from the first and second colors on a corresponding additional mold piece prior to spraying the bonding material, thereby facilitating production of a component having at least three different colors.

14. The method of claim 8, further comprising spraying a release agent to each of the mold pieces prior to spraying a corresponding coating.

15. A system for producing a multi-colored polymeric component, the system comprising:
a mold having at least two pieces separable from each other and configured to cooperate with each other to facilitate production of an integrated component;
at least one robotic spray arm configured to spray polymeric coatings on the at least two mold pieces, and further configured to spray a polymeric bonding material on at least a portion of each coating, thereby forming an integrated component; and
at least one controller for controlling operation of the at least one robotic spray arm such that a first piece of the mold is sprayed with a coating having a first color and a second piece of the mold is sprayed with a coating having a second color, at least one of the coatings being sprayed when the first and second mold pieces are separated from each other.

16. The system of claim 15, further comprising an actuator operable to effect movement of the first and second mold pieces proximate to each other prior to the bonding material being sprayed on the coatings.

17. The system of claim 16, wherein the coatings are sprayed at a first workstation, and the bonding material is sprayed at a second workstation, the system further comprising a conveyor configured to move the proximate mold pieces from the first workstation to the second workstation.

18. The system of claim 15, wherein the at least one robotic spray arm includes a first robotic spray arm configured to spray each of the mold pieces with a release agent prior to the mold pieces being sprayed with a coating.

19. The system of claim 18, wherein the at least one robotic spray arm includes second and third robotic spray arms configured to spray the first and second coatings, respectively, and a fourth robotic spray arm configured to spray the bonding material.

20. The system of claim 15, wherein the at least one robotic spray arm is further configured to spray at least one additional polymeric coating having at least one color different from the first and second colors on a corresponding additional mold piece prior to spraying the bonding material, thereby facilitating production of a component having at least three different colors.
